(19) United States
(12) Patent Application Publication
(10) Pub. No.: US 2026/0133840 A1
(43) Pub. Date: May 14, 2026

(54) METHODS AND SYSTEMS FOR PRE-FETCHING PAGE CONTENT BASED ON LLM RESPONSE

(71) Applicant: Shopify Inc., Ottawa (CA)

(72) Inventor: Andrew Musgrave, Ottawa (CA)

(21) Appl. No.: 18/943,035

(22) Filed: Nov. 11, 2024

(51) Int. Cl. G06F 9/50; G06F 21/62

(52) U.S. Cl. CPC G06F 9/5033; G06F 21/6209

(57) ABSTRACT

A computer-implemented method including parsing a stream of data; detecting an identifier for a resource within the stream of data; checking the detected identifier against a manifest; and based on the checking, prefetching the resource. Also, a computing device having a processor; a memory; and a communications subsystem, where the computing device is configured to parse a stream of data; detect an identifier for a resource within the stream of data; check the detected identifier against a manifest; and based on the check, prefetch the resource.

### FIELD OF THE DISCLOSURE

The present disclosure is related to user interface (UI) rendering in computing systems, and in particular relates to user interface rendering related to an artificial intelligence assistant.

### BACKGROUND

In Software as a Service (SaaS) or other similar platforms, a user may interact with an Artificial Intelligence (AI) assistant such as a chatbot to accomplish certain actions. Such AI assistants may, in some cases, be powered by Large Language Models (LLMs).

For example, a user may ask the chatbot how to accomplish a task, and the LLM powered chatbot may respond with a set of actions. Such actions may require navigating to various pages on a site. Thereafter, while performing the actions, the user may experience significant delays going to the various pages.

### SUMMARY

A chatbot or similar assistant may provide actions that a user can take to accomplish a task. For example, the assistant may direct a user to go to a particular page as part of the process to accomplish the task, and may even provide a link to the page. However, AI assistants tend to be slow and provide responses one token at a time. Further, the page that the assistant has directed the user to may in some cases be large, and require significant time to load. This all creates delay, diminishing user experience.

Further, in some cases, AI assistants may return results that are incorrect, for example by providing pages that do not exist. This is sometimes referred to as hallucination. Further, in some cases the results may direct the user to actions or pages that a user is not authorized to access.

The embodiments of the present disclosure overcome this by checking results against a manifest of valid pages or sites a user can navigate to, and further by pre-fetching pages that the user may navigate to based on the results provided by the assistant.

Therefore, in one aspect, a computer method may be provided. The computer method may include parsing a stream of data and detecting an identifier for a resource within the stream of data. The computer method may further include checking the detected identifier against a manifest and, based on the checking, prefetching the resource.

In some embodiments, the checking the detected identifier against the manifest may comprise verifying that the resource exists matches with the manifest.

In some embodiments, the checking the detected identifier against the manifest may comprise finding a uniform resource locator (URL) for the resource.

In some embodiments, the checking may determine at least one of: that the resource is on an allow list; or that the resource is not on a block list.

In some embodiments, the identifier for the resource may be at least one of: a hyperlink; a Uniform Resource Identifier (URI); and keywords for the resource.

In some embodiments the stream of data may be output from a Large Language Model (LLM).

In some embodiments the method may further comprise, prior to receiving the stream of data: providing a prompt to the LLM to complete a task; and receiving a response from the LLM, the response comprising the stream of data, wherein the resource is associated with a step in completing the task.

In some embodiments the resource is a task element within a website.

In some embodiments, multiple resources may be identified in the stream of data, the method may further include checking the multiple resources against the manifest; and based on the checking: prefetching a first resource; placing a second resource in a queue; and further to navigation to the first resource, prefetching the second resource.

In some embodiments, the parsing the stream of data may occur while the stream of data is being received at a computing device.

In a further aspect, a computing device having a processor; a memory; and a communications subsystem may be provided. The computing device may be configured to parse a stream of data; detect an identifier for a resource within the stream of data; check the detected identifier against a manifest; and based on the check, prefetch the resource.

In some embodiments, the computing device may be configured to check the detected identifier against the manifest by verifying that the resource exists matches with the manifest.

In some embodiments, the computing device may be configured to check the detected identifier against the manifest by finding a uniform resource locator (URL) for the resource.

In some embodiments, the computing device may be configured to check by determining at least one of: that the resource is on an allow list; or that the resource is not on a block list.

In some embodiments, the identifier for the resource may be at least one of: a hyperlink; a Uniform Resource Identifier (URI); and keywords for the resource.

In some embodiments, the stream of data may be output from a Large Language Model (LLM).

In some embodiments, the computing device may further be configured to, prior to receiving the stream of data: provide a prompt to the LLM to complete a task; and receive a response from the LLM, the response comprising the stream of data, wherein the resource is associated with a step in completing the task.

In some embodiments, multiple resources may be identified in the stream of data, the computing device being further configured to: check the multiple resources against the manifest; based on the check: prefetch a first resource; place a second resource in a queue; and further to navigation to the first resource, prefetch the second resource.

In some embodiments, the parsing the stream of data may occur while the stream of data is being received at a computing device.

In a further aspect, a non-transitory computer readable medium for storing instruction code may be provided. The instruction code, when processed by a processor of a computing device, may cause the computing device to parse a stream of data; detect an identifier for a resource within the stream of data; check the detected identifier against a manifest; and based on the check, prefetch the resource.

### BRIEF DESCRIPTION OF THE DRAWINGS

The present disclosure will be better understood with reference to the drawings, in which:

FIG. 1A is a block diagram of a simplified convolutional neural network, which may be used in examples of the present disclosure.

FIG. 1B is a block diagram of a simplified transformer neural network, which may be used in examples of the present disclosure.

FIG. 2 is a block diagram of an example computing system, which may be used to implement examples of the present disclosure.

FIG. 3 is a block diagram showing an example tree layout for task elements in a user interface.

FIG. 4 is a block diagram showing an example task element manifest for use in association with a task element.

FIG. 5 is a block diagram of an action tree structure that can be used as a manifest.

FIG. 6 is a block diagram showing an example user interface with an AI assistant used to assist in completing a task.

FIG. 7 is a dataflow diagram showing the parsing of a data stream, checking resources against a manifest, and preloading the resource at a client device.

FIG. 8 is a process diagram showing an example of parsing of streamed data to identify resources.

FIG. 9 is a dataflow diagram showing the parsing of a data stream, checking resources against a manifest, and preloading the resource at a server.

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

A web application, a SaaS platform, an online application, a hosted application, and/or a web service, among others, may be implemented as a series of pages or resources that are tied together using a manifest. The manifest in this case is any data structure that can be used to associate resources with actions. For example, a manifest may be a table that includes keywords and a Uniform Resource Location (URL) or Uniform Resource Identifier (URI) to find the resource.

In other cases, the manifest can be more complex. For example, the manifest may contain various information, including an indication of the resource the manifest is for; an indication of the loader to use for the task element; a list of children for the task element; metadata such as the scope of the element, the category of the element, a navigation path for the element, a description of the element, input metadata for the element, output metadata for the element, and keywords or terms for the element; eligibility or permissions used for the element, among other information.

In other cases, the manifest may be a tree of actions, which may provide conditions to move through the tree of actions. For example, such tree could be configured to map questions to tasks or actions the assistant then performs, which may in this case be preconfigured.

An LLM at the SaaS platform can be trained on the resources of the platform. In some embodiments the LLM training may be fine tuned using such manifest. In this regard, the AI assistant is supposed to only return items that can be found in the manifest.

Fine tuning is not necessarily the only way the LLM generates page references. The system may perform retrieval augmented generation (RAG) using a vector search of embeddings of a knowledge base. The knowledge base may be a database of help centre articles containing information about how to accomplish a certain task on the platform. The LLM may generate a response based on the results of the vector search. This response may then be parsed in order to identify resources according to the manifest and the pre-fetching may occur on that basis.

The platform may make an AI assistant available to a user, who could then ask the AI assistant how to accomplish a task, and receive details back including the pages to go to or other resources to use to accomplish the task. However, a user that is attempting to use the AI assistant may, in some cases, experience significant delays in accomplishing a task. In particular, the response may include various information about how to accomplish a task, including sites or pages to navigate to. However, when a user then goes to those pages, in some cases there can be significant lag in the loading of such pages, especially when such pages are large or contain a significant amount of data.

Further, AI assistants provide data back in a token by token manner, which can be slow. When the resource is provided early in the AI assistant response, pre-fetching can then save time once the resource is requested. Specifically, LLMs currently emit their output at a slow, non real-time pace, and so prefetching may further reduce delay, since the URL may be fetched by the time a response that includes that URL finishes being received and rendered.

In this regard, in accordance with embodiments of the present disclosure, a monitoring module may exist at either the client computing device or web server that would monitor a stream of data being returned by the AI assistant. The monitoring module may detect that the user has been directed to a resource such as a web page or form to accomplish the task the user wishes to perform.

In particular, the stream of data may contain identifying information for a resource. In some cases, this may be a Uniform Resource Locator (URL) such as a hyperlink. In some cases, this may in the form of Uniform Resource Information (URI), which may be associated with an address. In some cases, the indication may be in the form of keywords. For example, the words “Go to” or “click on” in the response may indicate that a resource is being referred to.

On finding the identifying information, the computing device may then go to the manifest and check the identifying information against the manifest. This may be done for several reasons. First, a check of the identifying information in the manifest may result in the correct URL for the resource being provided back to the computing device. For example, the LLM powered chatbot may return a URI, which could then be mapped to the URL by finding the URI in the manifest. In this case, by returning a URI, the chatbot can take advantage of efficiencies, since a URI may be shorter than a URL, and therefore use less tokens in the LLM system. Further, the returning of the URI may provide an identifier that is de-coupled from the actual implementation of the platform, and thus if the location of the resource changes, the LLM does not need to retrained, which may be computationally expensive. For example, if the LLM returns a message to “Go to ‘Theme Settings”, the system may look up theme settings in the manifest and find the URL presently associated with it. Such URL may be changed over time. For example, instead of a URL ‘ABC_Company.com/admin/theme/settings’ this may be changed to ABC_Company.com/admin/settings/theme-settings'. In this case, the manifest could be used to map the most recent and up to date URL to the URI.

The check against the manifest may further find keywords, or perform fuzzy matching, to find the location of the resource.

A second reason for checking the identifying information against the manifest may be for security. Specifically, the LLM assistant may be fine tuned to return information based on a defined schema, and point to resources that exist in the system. The check against the manifest can enhance security by ensuring the AI assistant is returning valid results and is not hallucinating.

Further, security may be enhanced by only allow prefetching on URLs that match an allow list (i.e. a white list) or those that do not match a block list (i.e. a black list)

Once the check against the manifest is performed, the computing device knows the address for the resource and that the resource is valid (and in some cases that pre-fetching is permitted). In this regard, the computing device can assume that a user who obtained this information will want to go to the resource, and in order to decrease the delay experienced by the user, the computing device may pre-fetch the resource and cache it for when the user navigates to the resource.

In some cases, the stream of data received from the LLM powered chatbot may contain information for a plurality of resources. In this case, if the resources may need to be accessed in order. Thus, the computing device may perform the above, namely extracting identifiers for each resource, checking each against the manifest, and finding a locator for each of the identified resources. In some cases, the computing device may then prefetch the first resource and put the remaining resource locators on a queue. Thereafter, once a navigation event to the first resource is performed, the computing device may prefetch the second resource, and so on.

However, in other cases the computing device may prefetch all the identified resources. The prefetching may be done in the order that the resources will likely be needed in some cases.

In some cases, if the user navigates somewhere besides the identified resource, the cache may be cleared to free resources.

Using the above, the results from an LLM powered assistant can be verified and a user experience enhanced by prefetching data. The above therefore both reduces wait times to accomplish a task and increases security for performing the task.

### Machine Learning and Computing Device

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publically-available text corpuses may be, e.g., fine-tuned by further training using the complete works of Shakespeare as training data samples (e.g., where the intended use of the ML model is generating a scene of a play or other textual content in the style of Shakespeare).

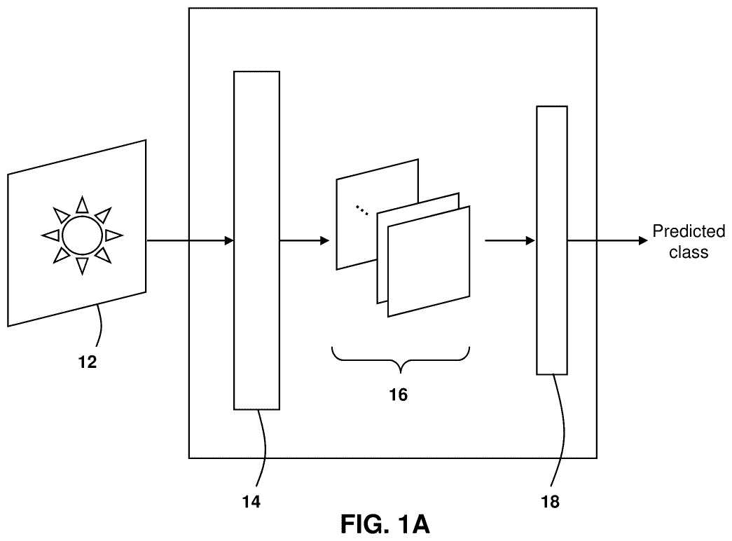

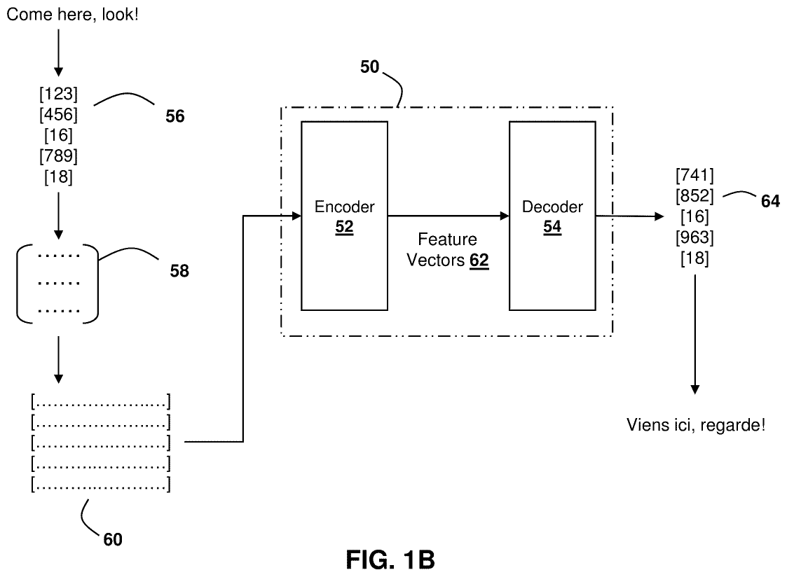

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), an End Of Text [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

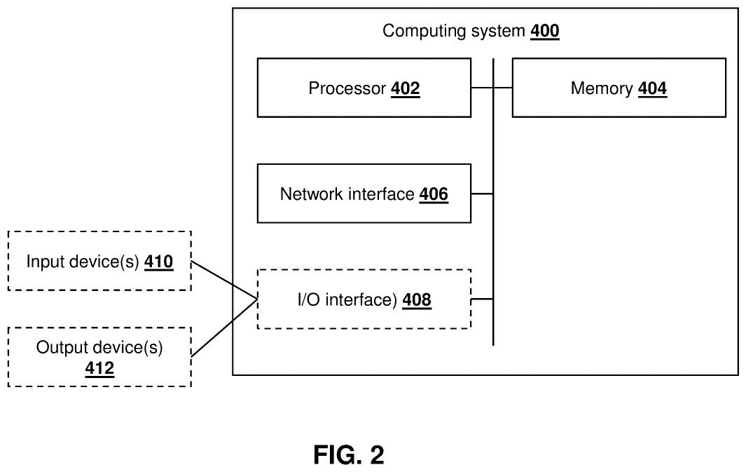

FIG. 2 illustrates an example computing system 400, which may be used to implement examples of the present disclosure, such as a prompt generation engine to generate prompts to be provided as input to a language model such as an LLM. Additionally or alternatively, one or more instances of the example computing system 400 may be employed to execute the LLM. For example, a plurality of instances of the example computing system 400 may cooperate to provide output using an LLM in manners as discussed above.

The example computing system 400 includes at least one processing unit, such as a processor 402, and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to the computing system 400 to carry out examples of the methods, functionalities, systems and modules disclosed herein.

The computing system 400 may also include at least one network interface 406 for wired and/or wireless communications with an external system and/or network (e.g., an intranet, the Internet, a Person to Person (P2P) network, a Wide Area Network (WAN) and/or a Local Area Network (LAN)). A network interface may enable the computing system 400 to carry out communications (e.g., wireless communications) with systems external to the computing system 400, such as a language model residing on a remote system.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400.

A computing system, such as the computing system 400 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

### User Interface to Perform Actions

Actions that a user is interested in performing may be performed on user interface that may be hierarchical in nature. For example, on a web page, a landing page may have a plurality of UI elements such as menus, links, forms or other elements which allow interaction with the website. Clicking through the menu, links, forms, or other such elements can lead to further pages or task elements having other menu items, links, forms or other elements.

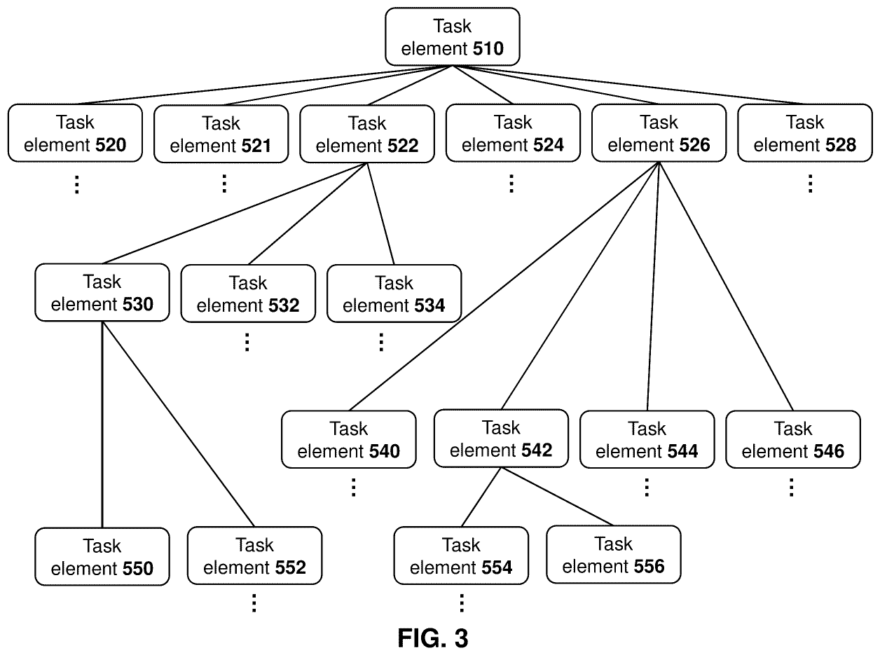

For example, reference is now made to FIG. 3. In the example of FIG. 3, a task element 510 may be an initial starting point on a user interface, for example the home screen of a web page. Task element 510 may have interactive UI components which may lead to a plurality of task elements therein, allowing the user to navigate through the user interface. For example, a menu or links on a webpage may allow a user to navigate to other pages, forms, content, sections, sidebars, widgets, among other options, collectively referred to herein as a task element. Thus, from task element 510, a plurality of task elements, labeled as task element 520, task element 521, task element 522, task element 524, task element 526 and task element 528 may be reached.

In many cases, each of such task elements may lead to other task elements within their structure. FIG. 3 is simplified to only show examples of some sub-task elements. For example, task element 522 is shown leading to task elements 530, 532 and 534.

Similarly, task element 526 is shown leading to task elements 540, 542, 544, and 546.

Following with the tree structure, such task elements can further have other task elements that they lead to. For example, task element 530 can lead to task elements 550 and 552. Task element 542 can lead to task elements 554 and 556 in the example of FIG. 3.

However, the example of FIG. 3 is merely provided for illustration showing a tree with a plurality of task elements and the structure of the tree is simplified. In practice, the structure of the tree may have different task elements, may be wider or narrower, may be deeper or shallower, may have links back to other task elements within the tree structure, thereby creating circular loops, among other options.

In the traditional hierarchical UI of FIG. 3, each task element to accomplish a task may be in different locations. As will be appreciated by those in the art, a user or administrator unfamiliar with the layout of the user interface may have difficulty navigating between the various task elements in order to accomplish the task.

In this regard, the user may request assistance from an AI assistant to accomplish the task. In some cases, to facilitate the AI assistant providing responses to queries, the various task elements within the user interface may be wrapped with a manifest providing details for the task element, including metadata about the task element, a hierarchical structure for the task element, eligibility or permissions used for the element, and/or loaders for use with the task element. The UI may have a plurality of such task elements, each with an associated task element manifest, where the plurality of associated task element manifests creates a resource map for the page or user interface.

However, in other cases, the manifest may comprise a tree of actions and conditions for such actions. Each are described below.

### Task Element Manifests

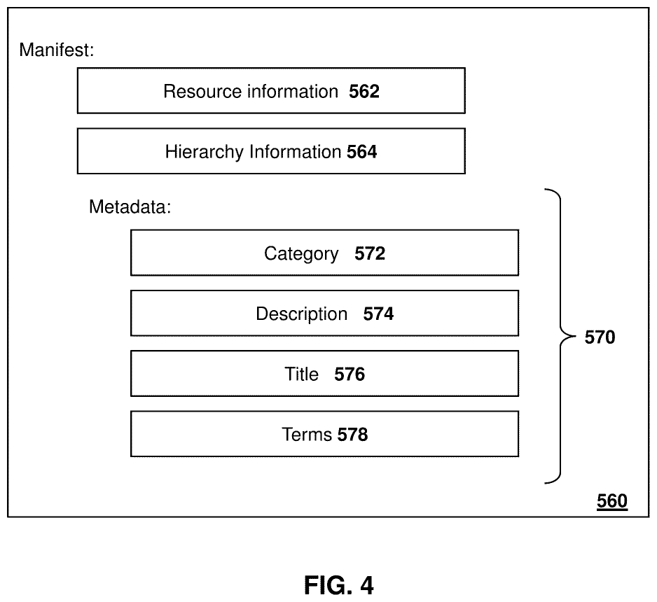

Task element manifests are now described with regards to non-limiting examples. In particular, reference is made to FIG. 4, which shows one example manifest 560. However, the manifest 560 of FIG. 4 is merely provided for illustration, and in some cases the components of manifest 560 may include only a subset of the elements described therein. In other cases, additional elements may be provided as part of the manifest.

In the example of FIG. 4, manifest 560 may include resource information, as shown at block 562. Resource information may include, for example, loaders that could be used to render the task element associated with manifest 560. Resource information may include permissions for the use of the task element associated with manifest 560. Resource information may include whether the manifest can be indexed or not. Resource information may include navigation paths to the component or task element itself. Resource information could include a scope for the task element. Resource information may include input metadata for the element, such as form schema and parameters to provide context for an action. Resource information may include output metadata for the element, such as information or results of the task element to enable the task element to be chained together with other task elements. Resource information may include endpoint or call back functions to allow the system to know where business logic is for processing an action using the task element. Other resource information could similarly be grouped within block 562.

Further, in some cases manifest 560 may include hierarchy information, as shown with block 564. In some cases, hierarchy information may simply hold information about children. Thus, in one case the manifest 560 could hold metadata about its task element, and information about its children. The children may each have their own manifest holding metadata about such child task element.

In some cases, the hierarchy information at block 564 may include information about the parent(s) of the present task element.

Thus, the metadata held in a task element manifest 560 may be hierarchical.

Task element manifest 560 may further include metadata 570 about the task element. Metadata 570 may include various information, and in the example of FIG. 4 includes category block 572, description block 574, title block 576, and terms or keywords block 578. However, in practice, the metadata may include more or less information, may be grouped or combined in different ways, and thus the example of FIG. 4 is provided for illustration only.

Category information at block 572 may include, for example, whether the task element relates to products or services. In some cases, the category may be related to particular products—for example sporting goods or kitchen wares. Other options for categories are possible.

A description block 574 may contain a plain language description of the functions and purpose of the task element. In some cases, description block 574 may encapsulate business logic to facilitate a chatbot/LLM to infer or deduce what to do and build the UI to do the action.

A title block 576 may provide a title or label for the task element.

A terms block 578 may provide for keywords or terms that could be relevant to the task element.

For example, one simplified manifest is shown in Table 1 below.

TABLE 1
Example Manifest

```
const routeManifest = {
  resource: ‘collection’,
  actionType: ‘list’,
  id: ‘collection:list’,
  loader: ‘./loader.ts’,
  url: ‘’,
  index: true,
  children: [ array of children ],
  parents: [ array of parent(s) ],
  metadata: {
    search: {
      scope: ‘shop’,
      category: ‘products’,
      navigationPath: [ ],
      description: ‘View, create and update collections to organize
        products by category’,
      title: ‘Collections List’,
      terms: [
        ‘collection’,
        ‘collections’,
        ‘view collections’,
        ‘list collections’,
        ‘categories’,
        ‘category’,
        ‘group products,
        ‘gallery’,
        ‘product gallery’,
        ‘automated collection’,
        ‘smart collection’,
        ‘manual collection,
        ‘product group’,
        ‘product groupings’,
        ‘grouping products’,
      ],
    }
  }
};
```

Thus, as seen in Table 1, the manifest includes routing information, hierarchical information, a description of the task element, terms or keywords used for the task element, and other similar metadata.

For manifest 560, in some cases, Route Manifests created by Blitz™ and Loaders created by React Router™ may be used as the underlying technology, though these may be annotated in a way that can be used by the LLM/AI. Additionally forms and form elements may be created with annotations that will be used by the LLM/AI both as input to provide understanding, and as output to generate form input.

Remix™ may be used for manifest 560 in some cases.

RedWoodJS™ is another framework that uses manifests, although under a different name (Link and named route functions)

Route Manifests have hierarchy. Instead of pulling in a single form element (an input box), the whole form as a set may be pulled in—or even higher in the hierarchy a whole widget that contains a form and multiple elements within the form and outside the form may be pulled in.

Forms and form elements may have additional annotations which can be used as input to the LLM to provide understanding of what can be done with the form or form element.

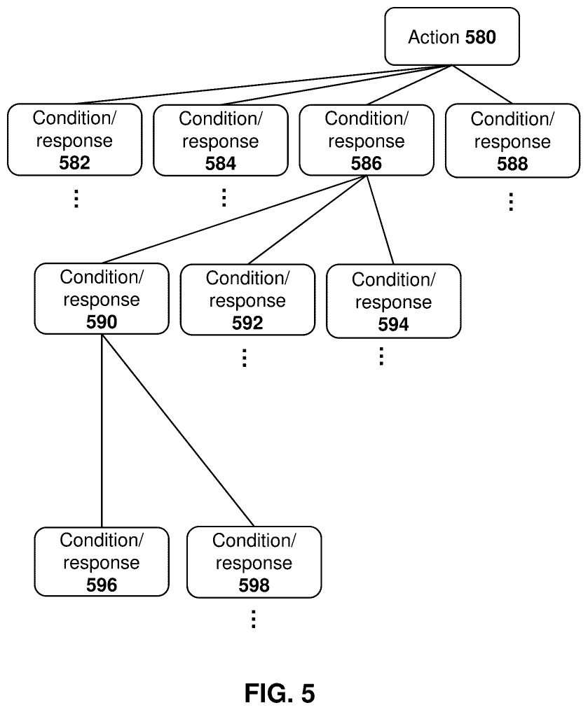

However, the manifest of FIG. 4 and Table 1 is only one example of a manifest, and the present disclosure is not limited to such manifest. For example, in some cases the manifest may be a tree of actions with conditions that could be traversed to provide valid responses. Reference is now made to FIG. 5.

In the example of FIG. 5, each action 580 could have a tree of conditions, responses and functionality associated therewith. For example, if the LLM identifies an action, the process may sequentially go through various conditions such as condition block 582, condition block 584, condition block 586 or condition block 588. Specifically, each condition may be tested in sequence and if a condition is met, then the response or action in that block of the tree may be performed.

In some cases, the action may be to perform or request more information and test such information against subsequent conditions. This is shown, for example, with condition response 586, which has several conditions that may be tried in order based on new information received, shown with condition block 590, condition block 592 and condition block 594.

Similarly, condition block 590 may request further information and provide condition block 596 and condition block 598, which may be tested sequentially.

Thus, an action 580 may consist of one or more steps where the steps in the action defined the conversation turns that follow input from a customer or client that triggered the action. Each condition block may further include other information, rules or metadata, and thus could form a manifest for the action.

In still further cases, the term “manifest” may simply refer to a lookup table.

Thus, as used herein, a manifest provides a framework or mapping to resources within the system. It could be used to tie a page together (handle routing, data loading, etc.), but it could be used as a descriptor to supplement and provide data, only handle routing, among other things. The present disclosure is not therefore limited to a particular manifest.

### Prefetching Resources

In some, non-limiting examples, the systems and methods of the present disclosure may be used with regard to an e-commerce platform. However, this is merely provided for illustration, and in other cases, other platforms could equally be sued.

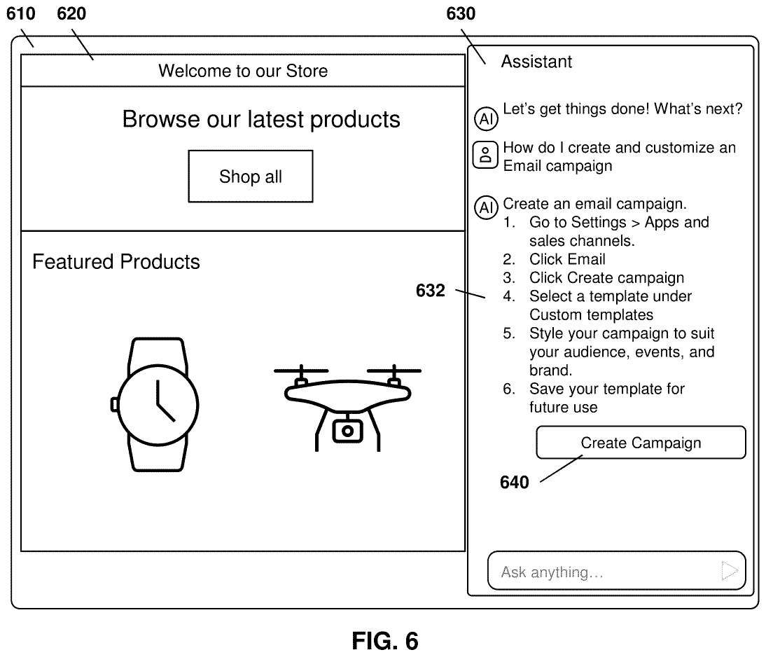

A user may wish to accomplish a task and may as an AI assistant how to perform such task. For example, reference is now made to FIG. 6, which shows a web page 610 that may represent an administrative portal of an electronic storefront. In some cases, such portal may provide an AI assistant 630 to assist a user or administrator of the site to accomplish tasks. The web page in this case may display an administrative page or mock-up of the storefront in a display 620.

In the example of FIG. 6, a user asks the AI assistant how to create an email campaign.

The AI assistant may then provide an answer 632, which may provide step by step instructions on how to create the e-mail campaign. For example, this may include navigating to a particular task element, such as a page or resource, and performing certain actions at that page or resource.

In some cases, the LLM may provide a link 640 to the task element 640. However, in other cases only the instructions are provided. Other options are possible.

The user may then navigate to the resource by following the instructions 632 or clicking on the link 640.

However, as will be appreciated by those in the art, such request, response and navigation may be slow and thus diminish the user experience. Specifically, the LLM assistant 630 may provide the instructions token by token, which may take some time. Further, the resource the user is directed to may in some cases be a very large resource that takes time to load.

Further, in some cases the assistant may provide information for resources that do not exist in the system, or to resources the user does not have access to. Thus, it may be beneficial to check the resource against a manifest.

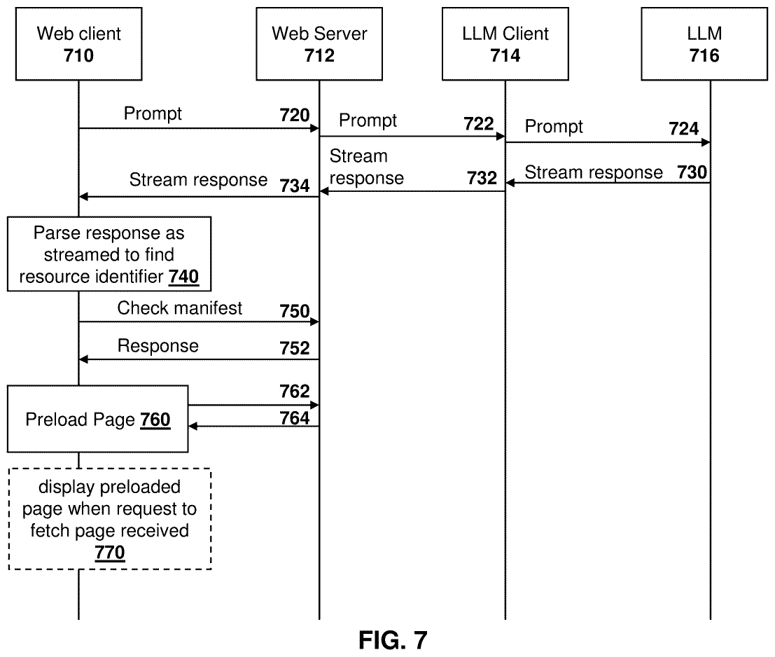

Reference is now made to FIG. 7, which shows one example of a system which may parse and pre-fetch resources. In the example of FIG. 7, the parsing and pre-fetching is done at a client device. However, in other embodiments described below, the parsing and pre-fetching may be performed at other computing devices.

In particular, in the embodiment of FIG. 7, a web client 710 may run on any computing device. Further, while the example of FIG. 7 shows a web client 710, in practice the functionality of client 710 could be performed by any application client, program, algorithm, or other logic executed on a computing device.

Web client 710 communicates with a web server 712, which may be any computing device or combination of computing devices capable of providing information back to web client 710.

In the embodiments of the present disclosure, the web client 710 provides prompts that are processed by an LLM 716, which is typically accessed through an LLM client 714.

Thus, web client 710 may generate a prompt 720 for the LLM, which is provided through a web server 712 to LLM client 714 as prompt 722. LLM client 714 sends the prompt 724 to the LLM 716.

LLM 716 may then generate a response and may stream such response back to the web client 710 as the response is generated. Specifically, this may be done by providing a streamed response 730 to LLM client 714, which provides the streamed response 732 back to web server 712. Web server 712 may then provide the streamed response 734 back to web client 710.

As the response stream is received by web client 710, it may parse the response at block 740 to detect if the response contains any resource identifiers. This may be done, for example, at a parsing module on the computing device of web client 710.

The parsing at block 740 may occur in various ways. In some cases, the parsing module may look for URIs such as Uniform Resource Names (URN) or URLs, links, keywords indicating a resource, among other options. As will be appreciated by those in the art, URNs may identify the resource but not provide a location for such resource. Conversely, a URL may both identify the resource and provide a location of to the resource. As such, a URN may be shorter (using less tokens), and thus better suited in some cases for an LLM response.

In some cases, a link or URI may not be provided in the response, and instead keywords such as “Go To” or “Click On” may indicate that a resource is being identified. In some cases, the schema for output produced by the LLM may provide for consistent terminology. However, in some cases, the parsing module may perform fuzzy matching to find a resource. Other options are possible.

In some cases, both a link and keywords may be provided, and rules may be used to determine the resource.

Other options are possible.

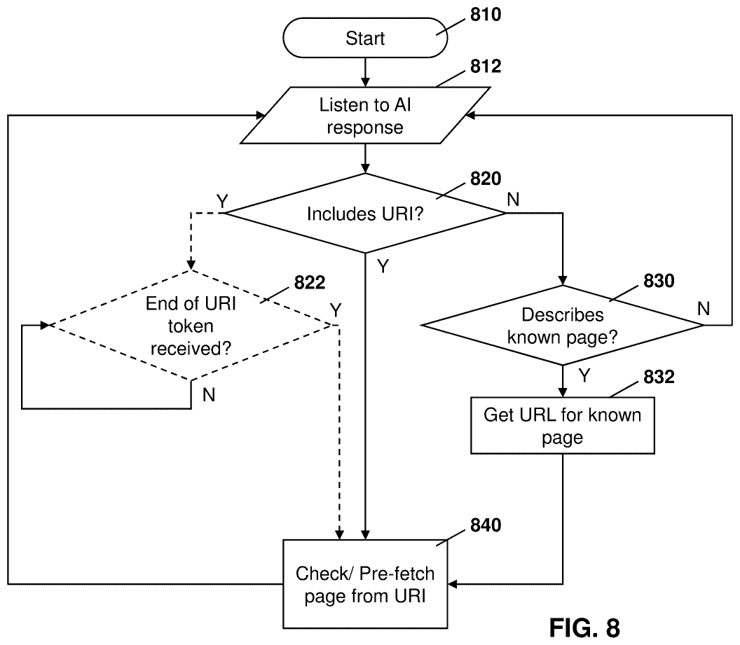

For example, a process at a parsing module is shown with regard to FIG. 8. However, the method of FIG. 8 is provided as only one example of a parsing process, and other processes could be used.

The process of FIG. 8 starts at block 810 and proceeds to block 812 in which the parsing module may listen to the AI response stream.

At block 820, a check is made to determine whether the response includes a URI. For example, in some cases, the URI may be identified based on syntax.

In some cases, if the streamed response includes a URI, a check may be made at block 822 to determine whether the end of the URI token has been received. If not, the process may continue to loop at block 822.

In other cases, the check at block 820 may include that the complete URI has been received.

From block 820, if the stream does not include a URI, the process proceeds to block 830 in which a check is made to determine whether the response stream includes or describes a known page. As indicated above, this may be based on keywords, fuzzy matching, or other options to parse the response stream.

From block 830, if the response stream does not describe a resource then the process may proceed back to block 820 to continue to monitor the response stream.

From block 830, if the response stream describes a known page, the process may proceed to block 832 in which the URL for the response stream may be retrieved, for example from a manifest such as that described with regard to FIG. 4 or FIG. 5.

From blocks 820 or 822, once the complete URI is received, or from block 832, the process may proceed to block 840 in which the page may be checked against the manifest and may be prefetched based on the URI or URL, as described below.

From block 840 the process may proceed back to block 812 to continue to monitor the AI response stream.

Referring again to FIG. 7, once the parsing at block 740 detects a resource identifier, the detected resource identifier may be checked against a manifest. This is shown in the example of FIG. 7 as a check manifest request 750 and a response 752. In this case, the manifest may be located at the web server or accessible from the web server 712.

However, in other embodiments, the manifest may be provided to web client 710 and thus the check may be performed at the web client rather than sending a request and receiving a response.

The check of the manifest may comprise several things. A first aspect may be to obtain a valid URL or link for the resource. For example, the resource identifier may identify the resource but not provide a particular location for such resource. The location of the resource may be stored at the manifest and thus can be retrieved. This further provides the benefit that if the resource changes location within the web site, the mapping at the manifest may be updated and thus the resource location may be correctly identified, regardless of whether the structure of the web page has changed.

For example, a resource may be identified as “Theme Settings”. However, as the site has evolved, the URL for this resource has moved from ‘ABC_Company.com/admin/theme/settings’ to ABC_Company.com/admin/settings/theme-settings'. The AI stream may in some cases only provide the resource identifier, or may provide the old address. However, the manifest may be updated as the website changes, and thus the resource location may be correctly obtained. Further, this allows the location of resources to change without having to retrain the LLM, which may be a computationally expensive process.

A second aspect of the check may be to verify that the resource is valid. In some cases, AI models may hallucinate and provide responses that are made up. In this case, the resource identified may be invalid and may not be part of the system. Thus, the check at request 750 may ensure that the resource is part of the manifest and, if not, may return an error or similar indication as part of response 752. Here, the resource being part of the manifest may comprise an exact match between the resource and the manifest, but in some cases the resource being part of the manifest could mean a match based on patterns or regexes or permitted prefixes or permitted domains, among other options.

In some cases an LLM at the SaaS platform can be trained on the resources of the platform. In some embodiments the LLM training may be fine tuned using such manifest. In this regard, the AI assistant is supposed to only return items that can be found in the manifest, but the check can ensure that is the case.

Also, the LLM may generate page references in other ways. The system may perform retrieval augmented generation (RAG) using a vector search of embeddings of a knowledge base. The knowledge base may be a database of help centre articles containing information about how to accomplish a certain task on the platform. The LLM may generate a response based on the results of the vector search. This response may then be parsed in order to identify resources according to the manifest and the pre-fetching may occur on that basis

A third aspect of the check may be to check that a user is permitted to access the resource. In this case, the manifest may be checked for permissions against the user permissions, and if the user is not permitted to access the resource, a response 752 may provide an indication that the user does not have sufficient permission to access the resource.

A fourth aspect of the check may be to ensure that the resource is permitted at the web client 710. For example, the resource may be placed on a ‘block list’, such as a blacklist, indicating that it should not be accessed. Conversely it may be placed on an ‘allow list’ such as a whitelist, indicating the resource should not be blocked.

In some cases, only a subset of the above aspects may be part of the check. In some cases, other aspects of the check may exist.

Based on the check, web client 710 may preload the page at block 760. This may involve sending a request 762 for the resource to web server 712 and receiving the page at response 764. Block 760 may cache the page until the user navigates to the page.

In some cases, the check of the manifest and the preloading of the page may be combined. Thus, request 750 and request 762 may be a single request and/or response 752 and response 764 may be part of the same response. Other options are possible.

Once the user navigates to the page, the page may be displayed, as shown at block 770.

In some cases, the parsing at block 740 may identify a plurality of resources. For example, the task that the user is asking about may be a multistage task which requires the user to interact with a plurality of task elements such as different web pages or resources. In this case, the prefetching at block 760 may involve prefetching only the first resource and queuing the prefetching for the other resources until after the first page has been navigated to.

In some cases, the multiple resources can be preloaded, for example based on an order in which the user is likely to access such resources or based on other heuristics.

In some cases, a subset of the plurality of resources can be prefetched and the remaining resources in the plurality of resources can be queued for prefetching until an action at the web client 710 occurs.

Other options are possible.

Further, in some cases the prefetching may take up too much memory, and the cache used for the prefetching may be intelligently flushed.

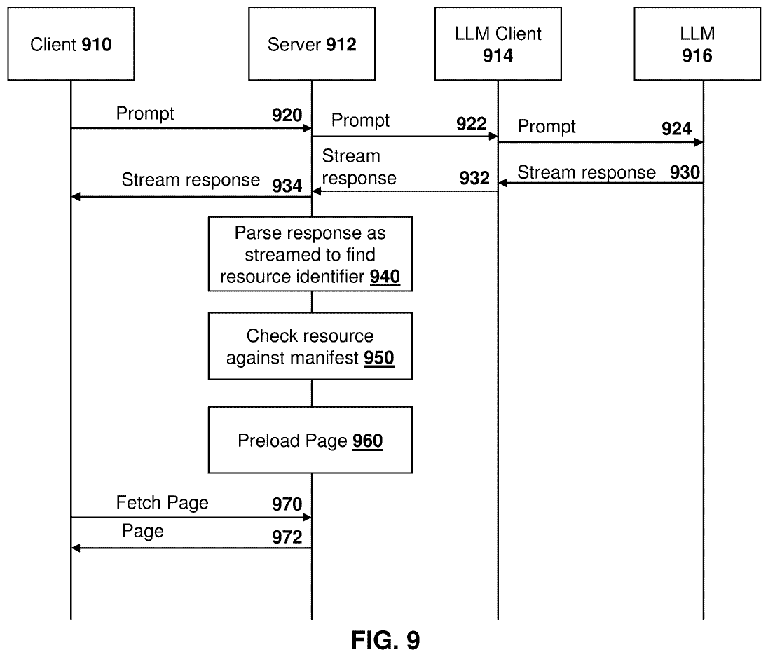

While the embodiment of FIG. 7 shows the parsing and preloading occurring at a client, in other case the parsing and preloading may occur at a server or group of servers. Reference is now made to FIG. 9.

In the embodiment of FIG. 9, a client 910 may run on any computing device. In one example of FIG. 9, client 910 may be a web client 910. However, in practice the functionality of client 910 could be performed by any application client, program, algorithm, or other logic executed on a computing device.

Client 910 communicates with a server 912, which may be any computing device or combination of computing devices capable of providing information back to client 910.

In the embodiments of the present disclosure, the client 910 provides prompts that are processed by an LLM 916, which is typically accessed through an LLM client 914.

Thus, client 910 may generate a prompt 920 for the LLM, which is provided through server 912 to LLM client 914 as prompt 922. LLM client 914 sends the prompt 924 to the LLM 916.

LLM 916 may then generate a response and may stream such response back to the client 910 as the response is generated. Specifically, this may be done by providing a streamed response 930 to LLM client 914, which provides the streamed response 932 back to server 912. Server 912 may then provide the streamed response 934 back to client 910.

As the response stream is received by server 912, it may parse the response at block 940 to find if the response contains any resource identifiers. This may be done, for example, at a parsing module on the server 912.

The parsing at block 940 may occur in various ways, as described above with regard to parsing block 740 in FIG. 7 and the example of FIG. 8.

Once the parsing at block 940 detects a resource identifier, the detected resource identifier may be checked against a manifest. This is shown in the example of FIG. 9 at a check manifest block 950. Block 950 is however a logical block, and the manifest may exist on another computing device or server, in which case the check at block 950 could include a request and response.

The check of the manifest may comprise the various aspects as described above with regards to FIG. 7.

Based on the check, server 912 may preload the page at block 960. This may involve sending a request for the resource to another server and receiving the page in a response. Block 960 may cache the page until the user navigates to the page.

In some cases, the check of the manifest and the preloading of the page may be combined. Thus, block 950 and 960 may be a single block. Other options are possible.

Once the user navigates to the page, a fetch page request 970 may be made and the cached page may be returned in page response 972.

In some cases, the page may be cached at client 910. This may involve the server 912 sending the page to client 910, and client 910 may cache the page until it is navigated to.

In some cases, the parsing at block 940 may identify a plurality of resources. For example, the task that the user is asking about may be a multistage task which requires the user to interact with a plurality of task elements such as different web pages or resources. In this case, the prefetching at block 960 may involve prefetching only the first resource and queuing the prefetching for the other resources until after the first page has been navigated to.

In some cases, the multiple resources can be preloaded in an order in which the user is likely to access such resources.

In some cases, a subset of the plurality of resources can be prefetched and the remaining resources in the plurality of resources can be queued for prefetching until an action at the client 910 occurs.

Other options are possible.

The embodiments of the present disclosure therefore provide for both checking and prefetching of resources using a manifest based on results from an LLM.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer method comprising:
parsing a stream of data;
detecting an identifier for a resource within the stream of data;
checking the detected identifier against a manifest; and
based on the checking, prefetching the resource.

2. The method of claim 1, wherein the checking the detected identifier against the manifest comprises verifying that the resource exists matches with the manifest.

3. The method of claim 1, wherein the checking the detected identifier against the manifest comprises finding a uniform resource locator (URL) for the resource.

4. The method of claim 1, wherein the checking determines at least one of: that the resource is on an allow list; or that the resource is not on a block list.

5. The method of claim 1, wherein the identifier for the resource is at least one of: a hyperlink; a Uniform Resource Identifier (URI); and keywords for the resource.

6. The method of claim 1, wherein the stream of data is output from a Large Language Model (LLM).

7. The method of claim 6, further comprising, prior to receiving the stream of data:
providing a prompt to the LLM to complete a task; and
receiving a response from the LLM, the response comprising the stream of data,
wherein the resource is associated with a step in completing the task.

8. The method of claim 7, wherein the resource is a task element within a website.

9. The method of claim 1, wherein multiple resources are identified in the stream of data, the method further comprising:
checking the multiple resources against the manifest;
based on the checking:
prefetching a first resource;
placing a second resource in a queue; and
further to navigation to the first resource, prefetching the second resource.

10. The method of claim 1, wherein the parsing the stream of data occurs while the stream of data is being received at a computing device.

11. A computing device comprising:
a processor;
a memory; and
a communications subsystem,
wherein the computing device is configured to:
parse a stream of data;
detect an identifier for a resource within the stream of data;
check the detected identifier against a manifest; and
based on the check, prefetch the resource.

12. The computing device of claim 11, wherein the computing device is configured to check the detected identifier against the manifest by verifying that the resource exists matches with the manifest.

13. The computing device of claim 11, wherein the computing device is configured to check the detected identifier against the manifest by finding a uniform resource locator (URL) for the resource.

14. The computing device of claim 11, wherein the computing device is configured to check by determining at least one of: that the resource is on an allow list; or that the resource is not on a block list.

15. The computing device of claim 11, wherein the identifier for the resource is at least one of: a hyperlink; a Uniform Resource Identifier (URI); and keywords for the resource.

16. The computing device of claim 11, wherein the stream of data is output from a Large Language Model (LLM).

17. The computing device of claim 16, wherein the computing device is further configured to, prior to receiving the stream of data:
provide a prompt to the LLM to complete a task; and
receive a response from the LLM, the response comprising the stream of data,
wherein the resource is associated with a step in completing the task.

18. The computing device of claim 11, wherein multiple resources are identified in the stream of data, the computing device being further configured to:
check the multiple resources against the manifest;
based on the check:
prefetch a first resource;
place a second resource in a queue; and
further to navigation to the first resource, prefetch the second resource.

19. The method of claim 1, wherein the parsing the stream of data occurs while the stream of data is being received at a computing device.

20. A non-transitory computer readable medium for storing instruction code that, when processed by a processor of a computing device, cause the computing device to:
parse a stream of data;
detect an identifier for a resource within the stream of data;
check the detected identifier against a manifest; and
based on the check, prefetch the resource.
